(19) United States
(12) Patent Application Publication
(10) Pub. No.: US 2026/0356662 A1
(43) Pub. Date: Nov. 12, 2026

(54) CHEMICAL LOOPING OF IRON-TIN POWDER BLEND FOR HYDROGEN PRODUCTION AND STORAGE

(71) Applicant: NORTHWESTERN UNIVERSITY, Evanston, IL (US)

(72) Inventors: David C. Dunand, Evanston, IL (US); Dingchang Zhang, Evanston, IL (US)

(21) Appl. No.: 19/719,690

(22) Filed: Jun. 25, 2026

Related U.S. Application Data
(63) Continuation-in-part of application No. PCT/US2025/010411, filed on Jan. 6, 2025.
(63) Continuation-in-part of application No. 18/367,019, filed on Sep. 12, 2023, now Pat. No. 12,544,833.
(60) Provisional application No. 63/406,320, filed on Sep. 14, 2022.
(60) Provisional application No. 63/619,401, filed on Jan. 10, 2024.
(60) Provisional application No. 63/830,599, filed on Jun. 26, 2025.

(51) Int. Cl. C01B 3/0031; C22C 38/00

(52) U.S. Cl. CPC C01B 3/0031; C22C 38/008

(57) ABSTRACT

Material, system, and method are provided for durable hydrogen production and storage utilizing a self-foaming Fe-xSn powder blend (x=0.5-40 at. % Sn). The material leverages a transient liquid-phase sintering swelling effect to actively suppress high-temperature densification and sintering during extended chemical looping. Under alternating hydrogen and steam atmospheres at temperatures between 300 °C and 800 °C, the tin component reversibly reduces to a transient liquid phase, generating stable microstructural porosity via liquid-depletion voids and volumetric intermetallic phase expansion. This diffusion-mediated strategy preserves open, high-surface-area reaction pathways without requiring complex mechanical shaping techniques, enabling stable and long-term cyclic hydrogen storage capacities up to 261 mL/g over at least 50 redox cycles.

### CROSS-REFERENCE TO RELATED PATENT APPLICATIONS

This application claims priority to and the benefit of U.S. Provisional Application No. 63/830,599, filed Jun. 26, 2025, which is incorporated herein in its entirety by reference.

This application is also a continuation-in-part application of PCT Patent Application No. PCT/US2025/010411, filed Jan. 6, 2025, which itself claims priority to and the benefit of U.S. Provisional Application No. 63/619,401, filed Jan. 10, 2024, and is a continuation-in-part application of U.S. patent application Ser. No. 18/367,019, filed Sep. 12, 2023, now U.S. Pat. No. 12,544,833, which claims priority to and the benefit of U.S. Provisional Application No. 63/406,320, filed Sep. 14, 2022, which are incorporated herein in their entireties by reference.

### FIELD OF THE INVENTION

The present invention generally relates to material science, particularly to chemical looping of iron-iin powder blend for hydrogen production and storage.

### BACKGROUND OF THE INVENTION

The background description provided herein is to present the context of the invention generally. The subject matter discussed in the background of the invention section should not be assumed to be prior art merely due to its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

Intermittent renewable sources, such as wind and solar, often generate electricity that mismatches grid demand, and this excess energy can be converted into hydrogen (H₂) via electrolysis for long-term storage. Large-scale hydrogen storage and transport face challenges due to their high costs and safety concerns. Metal oxides (MeOₓ) such as Fe oxides (FeO/Fe₃O₄), WO₂, and MoO₂ can be utilized for hydrogen storage through reversible hydrogen reduction and steam (H₂O) oxidation. In this process, metal oxides are first reduced by hydrogen to form reduced metals and steam (MeOₓ+xH₂=M+xH₂O), effectively storing the energy of hydrogen in a solid form with high volumetric energy density. When hydrogen is needed, the reduced metals react exothermically with steam to regenerate the oxides and release hydrogen (Me+xH₂O=MeOₓ+xH₂), completing a reversible redox cycle for hydrogen storage and release. Among these metal oxides, Fe oxides are promising for large-scale hydrogen storage and transport due to their abundance, low cost, low toxicity, and higher safety, making them advantageous for scalability. The stored hydrogen gas can be utilized for industrial decarbonization, such as in the production of green ammonia, green methane, and green steelmaking. It can also be converted back into electricity using hydrogen turbines or fuel cells to help balance the grid (panel (a) of FIG. 1). Rechargeable oxide batteries (ROBs), using redox cycling of Fe oxides, have been developed for grid-level energy storage and release.

A major challenge in the redox cycling of Fe oxides is the rapid loss of reactive surface area, driven by fast sintering kinetics at high temperatures, which significantly limits their practical viability. This challenge also applies to solar thermal water splitting, carbon dioxide utilization, and chemical looping combustion, where metal oxides are utilized as oxygen carriers. Currently, there are three effective strategies to achieve sintering inhibition. Adding inert powders such as titania, zirconia, and MgAl₂O₄ can prevent the adjacent Fe/Fe oxide powders from contacting and diffusing. However, it can decrease the specific hydrogen capacity and volumetric energy density of the powder blend. Alloying with reversible (H₂ reducible and steam oxidizable) refractory metals such as Mo, and W, which exhibit slow sintering kinetics, is another effective approach without significantly decreasing the specific hydrogen storage capacity. However, the formation of volatile MoO₂(OH)₂ and WO₂(OH)₂ phases can cause slow loss of alloying elements during the reaction. The last strategy is to form porous architectures with high surface area by freeze casting and 3D printing, which, however, is not suitable for scaling up due to their complicated processing and high cost.

Therefore, a heretofore unaddressed need exists in the art to address the aforementioned deficiencies and inadequacies.

### SUMMARY OF THE INVENTION

This invention introduces an innovative compositional design for the high-temperature redox cycling of iron oxide by utilizing a transient liquid-phase sintering induced swelling effect (or “self-foaming” behavior) to counter the rapid sintering kinetics and densification typical of pure iron-based powder beds. By incorporating a minor atomic concentration of tin (Sn) (x=0.5-40 at. % Sn) into an iron matrix, the invention exploits the low solubility ratio (S_{R}<1) of the iron-tin system. During hydrogen reduction at elevated temperatures, tin oxide reduces to a transient liquid tin phase that diffuses into the solid iron particles rather than dissolving them. This imbalanced diffusion leaves behind persistent “liquid-depletion” voids at former tin sites and triggers a net volumetric expansion through the generation of stable Fe—Sn intermetallic phases (such as FeSn and Fe₃Sn₂).

The inventive step relies on selecting a low-melting metal additive (Sn) that satisfies dual criteria: driving a microstructural swelling mechanism while maintaining strict thermodynamic redox reversibility under shifting hydrogen and steam atmospheres. Alternative low-melting additives capable of swelling (Al, Zn, Ga) fail because their oxides cannot be reduced by hydrogen under standard operating conditions, whereas Sn/SnO₂ fits perfectly within the required thermodynamic window. Additionally, the high contact angle of liquid tin on iron oxide surfaces produces a capillary pushing effect that works in tandem with the diffusion-mediated swelling to stabilize open pore channels. This ongoing cycle-by-cycle regeneration of the porous architecture achieves excellent cyclic durability (sustaining up to 261 mL/g of H₂ storage over 50 cycles). Crucially, it completely bypasses the need for complex, low-throughput structural shaping steps like freeze casting or 3D printing.

Aspects of the invention relate to a hydrogen storage system and method based on Fe—Sn powder beds that undergo reversible redox cycling. The invention leverages a transient liquid-phase swelling effect induced by tin (Sn) addition to iron oxide (Fe₂O₃) to preserve porosity and suppress densification during extended chemical redox cycling. When exposed alternately to hydrogen and steam at elevated temperatures, the Sn component temporarily melts and diffuses, forming porosity and Fe—Sn intermetallic phases. This swelling mechanism enables stable and high-capacity hydrogen storage over at least 50 redox cycles, achieving up to 261 mL/g H₂ storage. The invention does not require complex shaping methods and offers applications in chemical looping, solar thermochemical water splitting, and CO₂ utilization.

In one aspect, the invention relates to a material for hydrogen production and storage. The material comprises a Fe-xSn powder blend capable of exhibiting a transient liquid-phase sintering induced swelling effect and undergoing reversible transformations throughout redox cycling between oxidized and reduced states, wherein x represents a concentration (at. %) of tin (Sn) in the powder blend and is in a range of about 0.5-40 at. %.

In one embodiment, the Fe-xSn powder blend is capable of undergoing the redox cycling under alternating hydrogen and steam atmospheres at temperatures between about 300 °C and about 800 °C.

In one embodiment, the Fe-xSn powder blend is configured such that during redox cycling, Sn forms a transient liquid phase that induces a swelling effect, resulting in the preservation of porosity and suppression of densification in the Fe-xSn powder blend over multiple redox cycles.

In one embodiment, the swelling effect is initiated at a temperature of at least 440 °C in a powder blend of Fe₂O₃ and SnO₂, corresponding to reduction of Fe₃O₄ and SnO₂ and subsequent intermetallic formation with Fe.

In one embodiment, the Sn concentration is about 25-40 at. % to achieve a balance between volume contraction due to oxide reduction and expansion from the swelling effect.

In one embodiment, the redox cycling occurs at approximately 650 °C under alternating streams of hydrogen and steam carried by an inert gas.

In one embodiment, the Fe-xSn powder blend exhibits the transient liquid-phase sintering induced swelling effect during hydrogen reduction due to the formation of liquid Sn, thereby preserving porosity and reactive surface area during at least 50 redox cycles.

In one embodiment, the porosity is generated via a combination of void formation at former Sn sites; volumetric expansion from intermetallic Fe—Sn phase formation; and suppression of sintering due to reduced solid-solid connectivity.

In one embodiment, the Fe-xSn powder blend comprises an iron (Fe) or Fe-containing powder and a Tin (Sn) or Sn-containing powder.

In one embodiment, the Fe or Fe-containing powder comprises a Fe powder, a Fe-rich powder, and/or a Fe-containing oxide powder, and the Sn or Sn-containing powder comprises a Sn powder, a Sn-rich powder, and/or a Sn-containing oxide powder.

In one embodiment, the Fe or Fe-containing powder comprises iron oxide (Fe₂O₃), and the Sn or Sn-containing powder comprises tin oxide (SnO₂).

In one embodiment, the redox cycling involves reversible transformations between Fe, FeO, Fe₃O₄, Sn, SnO₂, and Fe—Sn intermetallic phases.

In one embodiment, the Fe-xSn powder blend is produced by ball milling Fe₂O₃ and SnO₂ powders followed by redox cycling without the use of shaping techniques such as freeze casting or 3D printing.

In one embodiment, the Fe-xSn powder blend is of Fe-1Sn, Fe-5 Sn, Fe-10 Sn, Fe-18 Sn, Fe-20 Sn, Fe-25 Sn, Fe-30 Sn, Fe-33 Sn, or Fe-40 Sn.

In one embodiment, the Fe-xSn powder blend achieves a hydrogen storage capacity of up to about 261 mL/g after 50 cycles.

In another aspect, the invention relates to a redox system for hydrogen production and storage. The redox system comprises a powder bed comprising a Fe-xSn powder blend capable of exhibiting a transient liquid-phase sintering induced swelling effect and undergoing reversible transformations throughout redox cycling between oxidized and reduced states, wherein x represents a concentration (at. %) of tin (Sn) in the powder blend and is in a range of about 0.5-40 at. %; a redox reactor configured to alternately expose the powder bed to a hydrogen-containing gas and a steam-containing gas; and a heating module configured to maintain the powder bed at a temperature between about 300 °C and about 800 °C during operation.

In one embodiment, the Fe-xSn powder blend is capable of undergoing the redox cycling under alternating hydrogen and steam atmospheres at temperatures between about 300 °C and about 800 °C.

In one embodiment, the Fe-xSn powder blend is configured such that during redox cycling, Sn forms a transient liquid phase that induces a swelling effect, resulting in the preservation of porosity and suppression of densification in the Fe-xSn powder blend over multiple redox cycles.

In one embodiment, the swelling effect is initiated at a temperature of at least 440 °C in a powder blend of Fe₂O₃ and SnO₂, corresponding to reduction of Fe₃O₄ and SnO₂ and subsequent intermetallic formation with Fe.

In one embodiment, the Sn concentration is about 25-40 at. % to achieve a balance between volume contraction due to oxide reduction and expansion from the swelling effect.

In one embodiment, the heating module is configured to maintain the temperature at approximately 650 °C.

In one embodiment, the Fe-xSn powder blend exhibits the transient liquid-phase sintering induced swelling effect during hydrogen reduction due to the formation of liquid Sn, thereby preserving porosity and reactive surface area during at least 50 redox cycles.

In one embodiment, the powder bed comprises porosity formed at locations previously occupied by molten tin.

In one embodiment, the porosity is maintained through volumetric expansion of Fe-containing intermetallic phases and reduced particle connectivity.

In one embodiment, the powder bed further comprises Fe—Sn intermetallic phases including FeSn, Fe₃Sn₂, and/or Fe₅Sn₃.

In one embodiment, the Fe-xSn powder blend comprises an iron (Fe) or Fe-containing powder and a Tin (Sn) or Sn-containing powder.

In one embodiment, the Fe or Fe-containing powder comprises a Fe powder, a Fe-rich powder, and/or a Fe-containing oxide powder, and the Sn or Sn-containing powder comprises a Sn powder, a Sn-rich powder, and/or a Sn-containing oxide powder.

In one embodiment, the Fe or Fe-containing powder comprises iron oxide (Fe₂O₃), and the Sn or Sn-containing powder comprises tin oxide (SnO₂).

In one embodiment, the redox cycling involves reversible transformations between Fe, FeO, Fe₃O₄, Sn, SnO₂, and Fe—Sn intermetallic phases.

In one embodiment, the system achieves a hydrogen storage capacity of up to about 261 mL/g after 50 cycles.

In one embodiment, the system achieves at least 50 redox cycles with less than 25% loss of hydrogen storage capacity.

In one embodiment, the reactor includes an inlet for hydrogen gas and an inlet for water vapor carried by an inert gas.

In one embodiment, the system avoids the need for mechanical structuring processes including freeze casting or 3D printing to maintain powder morphology.

In a further aspect, the invention relates to a method for cyclic hydrogen production and storage. The method comprises providing a powder bed comprising a Fe-xSn powder blend capable of exhibiting a transient liquid-phase sintering induced swelling effect and undergoing reversible transformations throughout redox cycling between oxidized and reduced states, wherein x represents a concentration (at. %) of tin (Sn) in the powder blend and is in a range of about 0.5-40 at. %; heating the powder bed to a temperature between about 300 °C and about 800 °C; and alternately introducing a hydrogen-containing (H₂) gas and steam-containing (H₂O vapor) gas into the powder bed. During reduction, Sn forms a transient liquid phase that induces a swelling effect, generating and preserving porosity in the powder bed.

In one embodiment, the hydrogen-containing gas comprises pure hydrogen and the steam-containing gas comprises water vapor carried by an inert gas.

In one embodiment, the redox cycle comprises a period of time of hydrogen exposure followed by the period of time of steam exposure.

In one embodiment, during the reduction, voids are formed at locations of former Sn particles.

In one embodiment, liquid Sn reacts with metallic iron to form Fe—Sn intermetallic phases that contribute to volumetric expansion and porosity stabilization.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows schematically application scenario and composition design according to embodiments of the invention. Panel (a): Schematic illustration of application scenarios where Fe-based oxides serve as hydrogen storage materials, enabling energy storage when renewable energy output exceeds grid demand. Panel (b): Solubility ratio (S_{Fe in liquid}/S_{liquid in Fe-X}) as a function of temperature for low-melting metals (X). Schematic illustration of swelling effect from transient liquid sintering (TLS) (c) Gibbs free energy of formation for Fe₃O₄, FeO, and SnO₂ in the temperature range of 300-800 °C. Other oxides that could leverage the swelling effect from TLS (shown in panel (b)) are excluded due to their difficulty to undergo steam oxidation or H₂ reduction during redox cycling.

FIG. 2 shows schematically phase evolution and surface morphology according to embodiments of the invention. Panel (a): In situ X-ray diffraction (XRD, transmitted) of a powder blend of Fe₂O₃—SnO₂ (target composition: Fe-40Sn) during three sequential stages: (bottom) H₂ reduction (100-650 °C), (middle) steam oxidation at 650 °C for 90 minutes, (top) H₂ reduction at 650 °C for 90 minutes. Panel (b): Normalized peak intensity of the phases identified in (a), corresponding to the three stages from bottom to top. Panel (c): Surface morphology of Fe-40Sn (left) Fe₃O₄—SnO₂ after steam oxidation and (right) FeSn intermetallic phase after H₂ reduction at 650 °C. Panel (d): Fe—Sn binary phase diagram and Panel (e): Fe—Sn—O ternary phase diagrams at 475 °C and 800 °C (650 °C not available); the blue line illustrates the composition trajectory and phases forming during reduction and oxidation of a Fe-40Sn target composition.

FIG. 3 shows schematically redox of Fe—Sn powder blends. according to embodiments of the invention. Panel (a): Schematic illustration of loosely packed Fe—Sn powder beds in alumina crucibles undergoing hydrogen storage and release through steam oxidation and hydrogen reduction. Panel (b): SEM-BSE images of Fe₃O₄+SnO₂ powder blends, with target compositions of Fe, Fe-10Sn, Fe-25Sn, and Fe-40Sn. Panel (c): Optical top-view images of Fe, Fe-10Sn, Fe-25Sn, and Fe-40Sn powder beds showing the evolution of shrinkage during redox cycling at 650 °C, from the initial oxide state (0 cycle) to the final reduced state (50.5 cycles). Panel (d): XRD patterns of cross-sections of Fe, Fe-10Sn, Fe-25Sn, and Fe-40Sn samples after 50 redox cycles. Panel (e): SEM-BSE images of the cross-sections (side views) of the Fe, Fe-10Sn, Fe-25Sn, and Fe-40Sn reduced powder beds after 10.5 cycles redox cycling. Panel (f): Hydrogen storage capacity of Fe, Fe-10Sn, Fe-25Sn, and Fe-40Sn as a function of redox cycles. (H₂ density at 0 °C and 1 atm) Inset: corresponding radial shrinkage as a function of redox cycles for each composition.

FIG. 4 shows schematically microstrucrual evolution according to embodiments of the invention. Panel (a): SEM-BSE cross-section images of Fe, Fe-10Sn, Fe-25Sn, and Fe-40Sn powder beds after the first H₂ reduction from the oxide state (0.5 cycle) and after subsequent steam oxidation (1 cycle). Panel (b): Schematic illustration of hydrogen reduction followed by steam oxidation process for the loosely packed Fe-40Sn powder blend, highlighting the mechanism for pore formation driven by transient liquid swelling. Panel (c): SEM-BSE cross-section images of Fe-40Sn powder beds after 50 (oxidized) and 50.5 (reduced) redox cycles.

FIG. 5 shows SEM-BSE cross-section images of Fe, Fe-10Sn, Fe-25Sn, and Fe-40Sn powder beds after the 2 cycle (steam oxidized) and after subsequent H₂ reduction (2.5 cycle).

FIG. 6 shows SEM-BSE cross-section images of Fe, Fe-10Sn, Fe-25Sn, and Fe-40Sn powder beds after the 10 cycles (steam oxidized) and after subsequent H₂ reduction (10.5 cycles).

FIG. 7 shows SEM-BSE cross-section images of Fe, Fe-10Sn, Fe-25Sn, and Fe-40Sn powder beds after the 50 cycles (steam oxidized) and after subsequent H₂ reduction (50.5 cycles).

### DETAILED DESCRIPTION OF THE INVENTION

The invention will now be described more fully hereinafter with reference to the accompanying drawings, in which exemplary embodiments of the invention are shown. However, this invention may be embodied in many different forms and should not be construed as limited to the embodiments set forth herein. Rather, these embodiments are provided so that this specification will be thorough and complete and fully convey the invention's scope to those skilled in the art. Like reference numerals refer to like elements throughout.

The terms used in this specification generally have their ordinary meanings in the art, within the context of the invention, and in the specific context where each term is used. Certain terms used to describe the invention are discussed below, or elsewhere in the specification, to provide additional guidance to the practitioner regarding the description. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, or section without departing from the invention's teachings.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures. is turned over, elements described as being on the “lower” side of other elements would then be oriented on “upper” sides of the other elements. The exemplary term “lower”, can, therefore, encompasses both an orientation of “lower” and “upper,” depending on the particular orientation of the figure. Similarly, if the device in one of the figures is turned over, elements described as “below” or “beneath” other elements would then be oriented “above” the other elements. Therefore, the exemplary terms “below” or “beneath” can encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this specification, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification, and will not be interpreted in an idealized or overly formal sense unless expressly so defined herein.

As used in this specification, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this specification, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in a different order (or concurrently) without altering the principles of the invention.

Chemical looping with Fe powders has been regarded as a promising approach for hydrogen production and storage due to iron's abundance and low cost. However, the rapid sintering kinetics of Fe powders at high temperatures (500-800 °C) significantly reduce their effective surface area, hindering the fast oxidation and reduction required for efficient hydrogen release and consumption. This issue severely limits the cyclability of Fe powders in chemical looping processes and poses challenges for large-scale industrial applications.

To address these challenges, various strategies have been proposed to mitigate sintering, including the addition of reversible refractory metal elements. While certain refractory metals, such as tungsten (W) effectively slow the sintering kinetics of Fe, their high density (19.4 g/cm³) dramatically increases the weight of powder blends. This additional weight presents challenges for efficient transport, especially in applications where hydrogen storage and transportation are critical, such as in geothermal energy, hydropower, and wind energy projects located in remote areas with limited access to electrical grids.

This invention introduces a fundamentally new mechanism for preserving porosity and reactive surface area in Fe-based redox materials for hydrogen storage: a transient liquid-phase swelling effect induced by alloying with tin (Sn). Unlike prior approaches that use inert additives (which dilute capacity), refractory alloying elements such as W or Mo (which are heavy or form volatile species), or complex shaping methods (freeze casting, 3D printing), the Fe—Sn system leverages the reversible Sn/SnO₂ redox couple. During hydrogen reduction, SnO₂ reduces to liquid Sn, which has a low solubility ratio (S_{R}<1) in Fe, causing liquid to diffuse into solid particles and leave behind pores at former Sn sites. This swelling counteracts the densification and sintering that plague pure Fe powders. The Sn addition (0.5-40 at. %, preferably 25-40 at. %) enables stable hydrogen storage over at least 50 cycles, achieving up to 261 mL/g H₂—about 22× that of pure Fe. The invention requires no freeze casting or 3D printing, uses low-density Sn (7.3 g/cm³ vs. W at 19.4 g/cm³), and relies on a self-regenerating swelling mechanism each redox cycle.

In the invention, Sn (7.3 g/cm³) is introduced as a relatively lightweight element that effectively prevents the sintering of Fe (7.8 g/cm³) powders by a brand-new mechanism. This approach marks the first application of reversible reduction/oxidation of Sn for redox cycling of Fe, offering a new promising solution for enhancing the cyclability and efficiency of Fe-based hydrogen production and storage systems. In this technology, iron (Fe) powders are alloyed with tin (Sn) to slow down the sintering during its oxidation and reduction processes. The microstructure of Fe powders with a Sn content from 0.5 at. % to 40 at. % are studied after various reduction/oxidation cycles. Our finding shows that alloying Fe powders with Sn can effectively inhibit the sintering of iron powders and maintain its porous microstructure for hydrogen release and consumption.

The Fe₂O₃—SnO₂ powder blends were prepared by mixing Fe₂O₃ (Noah Technologies, 99.9%, <3 μm) and SnO₂ (US Nano Research, 99.7%) using zirconia balls in a ball mill for 24 hours with a ball-to-powder weight ratio of 5:1. To achieve specific compositions, varying amounts of SnO₂ powder were added, resulting in Fe-10 at. %/19 wt. % Sn, Fe-25 at. %/41 w t.% Sn, and Fe-40 at. %/59 wt. % Sn blends. Approximately 40 mg of the ball-milled, loosely packed powder blend was weighed and placed into alumina crucibles for chemical looping tests.

The chemical looping experiments were conducted at 650 °C with a heating rate of 10 °C/min in an alumina tube furnace (inner diameter: 20 mm, length: 500 mm). Pure H₂ gas (UH P, 200 sccm) and steam (H₂O vapor) were alternately introduced into the furnace. Argon gas (UHP, 120 sccm) was used to carry H₂O vapor by passing through a heated deionized water bubbler maintained at 93 °C, creating a water vapor pressure of 770 mbar.

Each chemical looping cycle included a 90-minute reduction step in H₂ gas, followed by a 90-minute oxidation step in H₂O vapor, with automatic gas switching between the two steps. After completing the assigned chemical looping cycles, the samples were cooled to room temperature at a rate of about 5 °C/min. Reduced samples were cooled under 100 sccm H₂, while oxidized samples were cooled under 20 sccm of Ar-4% H₂.

Without intent to limit the scope of the invention, exemplary embodiments of the invention are given below.

In one aspect, the invention relates to a material for hydrogen production and storage. The material comprises a Fe-xSn powder blend capable of exhibiting a transient liquid-phase sintering induced swelling effect and undergoing reversible transformations throughout redox cycling between oxidized and reduced states, wherein x represents a concentration (at. %) of tin (Sn) in the powder blend and is in a range of about 0.5-40 at. %.

In one embodiment, the Fe-xSn powder blend is capable of undergoing the redox cycling under alternating hydrogen and steam atmospheres at temperatures between about 300 °C and about 800 °C.

In one embodiment, the Fe-xSn powder blend is configured such that during redox cycling, Sn forms a transient liquid phase that induces a swelling effect, resulting in the preservation of porosity and suppression of densification in the Fe-xSn powder blend over multiple redox cycles.

In one embodiment, the swelling effect is initiated at a temperature of at least 440 °C in a powder blend of Fe₂O₃ and SnO₂, corresponding to reduction of Fe₃O₄ and SnO₂ and subsequent intermetallic formation with Fe.

In one embodiment, the Sn concentration is about 25-40 at. % to achieve a balance between volume contraction due to oxide reduction and expansion from the swelling effect.

In one embodiment, the redox cycling occurs at approximately 650 °C under alternating streams of hydrogen and steam carried by an inert gas.

In one embodiment, the Fe-xSn powder blend exhibits the transient liquid-phase sintering induced swelling effect during hydrogen reduction due to the formation of liquid Sn, thereby preserving porosity and reactive surface area during at least 50 redox cycles.

In one embodiment, the porosity is generated via a combination of void formation at former Sn sites; volumetric expansion from intermetallic Fe—Sn phase formation; and suppression of sintering due to reduced solid-solid connectivity.

In one embodiment, the Fe-xSn powder blend comprises an iron (Fe) or Fe-containing powder and a Tin (Sn) or Sn-containing powder.

In one embodiment, the Fe or Fe-containing powder comprises a Fe powder, a Fe-rich powder, and/or a Fe-containing oxide powder, and the Sn or Sn-containing powder comprises a Sn powder, a Sn-rich powder, and/or a Sn-containing oxide powder.

In one embodiment, the Fe or Fe-containing powder comprises iron oxide (Fe₂O₃), and the Sn or Sn-containing powder comprises tin oxide (SnO₂).

In one embodiment, the redox cycling involves reversible transformations between Fe, FeO, Fe₃O₄, Sn, SnO₂, and Fe—Sn intermetallic phases.

In one embodiment, the Fe-xSn powder blend is produced by ball milling Fe₂O₃ and SnO₂ powders without the use of shaping techniques such as freeze casting or 3D printing.

In one embodiment, the Fe-xSn powder blend is of Fe-1Sn, Fe-5 Sn, Fe-10 Sn, Fe-18 Sn, Fe-20 Sn, Fe-25 Sn, Fe-30 Sn, Fe-33 Sn, or Fe-40 Sn.

In one embodiment, the Fe-xSn powder blend achieves a hydrogen storage capacity of up to about 261 mL/g after 50 cycles.

In another aspect, the invention relates to a redox system for hydrogen production and storage. The redox system comprises a powder bed comprising a Fe-xSn powder blend capable of exhibiting a transient liquid-phase sintering induced swelling effect and undergoing reversible transformations throughout redox cycling between oxidized and reduced states, wherein x represents a concentration (at. %) of tin (Sn) in the powder blend and is in a range of about 0.5-40 at. %; a redox reactor configured to alternately expose the powder bed to a hydrogen-containing gas and a steam-containing gas; and a heating module configured to maintain the powder bed at a temperature between about 300 °C and about 800 °C during operation.

In one embodiment, the Fe-xSn powder blend is capable of undergoing the redox cycling under alternating hydrogen and steam atmospheres at temperatures between about 300 °C and about 800 °C.

In one embodiment, the Fe-xSn powder blend is configured such that during redox cycling, Sn forms a transient liquid phase that induces a swelling effect, resulting in the preservation of porosity and suppression of densification in the Fe-xSn powder blend over multiple redox cycles.

In one embodiment, the swelling effect is initiated at a temperature of at least 440 °C in a powder blend of Fe₂O₃ and SnO₂, corresponding to reduction of Fe₃O₄ and SnO₂ and subsequent intermetallic formation with Fe.

In one embodiment, the Sn concentration is about 25-40 at. % to achieve a balance between volume contraction due to oxide reduction and expansion from the swelling effect.

In one embodiment, the heating module is configured to maintain the temperature at approximately 650 °C.

In one embodiment, the Fe-xSn powder blend exhibits the transient liquid-phase sintering induced swelling effect during hydrogen reduction due to the formation of liquid Sn, thereby preserving porosity and reactive surface area during at least 50 redox cycles.

In one embodiment, the powder bed comprises porosity formed at locations previously occupied by molten tin.

In one embodiment, the porosity is maintained through volumetric expansion of Fe-containing intermetallic phases and reduced particle connectivity.

In one embodiment, the powder bed further comprises Fe—Sn intermetallic phases including FeSn, Fe₃Sn₂, and/or Fe₅Sn₃.

In one embodiment, the Fe-xSn powder blend comprises an iron (Fe) or Fe-containing powder and a Tin (Sn) or Sn-containing powder.

In one embodiment, the Fe or Fe-containing powder comprises a Fe powder, a Fe-rich powder, and/or a Fe-containing oxide powder, and the Sn or Sn-containing powder comprises a Sn powder, a Sn-rich powder, and/or a Sn-containing oxide powder.

In one embodiment, the Fe or Fe-containing powder comprises iron oxide (Fe₂O₃), and the Sn or Sn-containing powder comprises tin oxide (SnO₂).

In one embodiment, the redox cycling involves reversible transformations between Fe, FeO, Fe₃O₄, Sn, SnO₂, and Fe—Sn intermetallic phases.

In one embodiment, the system achieves a hydrogen storage capacity of up to about 261 mL/g after 50 cycles.

In one embodiment, the system achieves at least 50 redox cycles with less than 25% loss of hydrogen storage capacity.

In one embodiment, the reactor includes an inlet for hydrogen gas and an inlet for water vapor carried by an inert gas.

In one embodiment, the system avoids the need for mechanical structuring processes including freeze casting or 3D printing to maintain powder morphology.

In a further aspect, the invention relates to a method for cyclic hydrogen production and storage. The method comprises providing a powder bed comprising a Fe-xSn powder blend capable of exhibiting a transient liquid-phase sintering induced swelling effect and undergoing reversible transformations throughout redox cycling between oxidized and reduced states, wherein x represents a concentration (at. %) of tin (Sn) in the powder blend and is in a range of about 0.5-40 at. %; heating the powder bed to a temperature between about 300 °C and about 800 °C; exposing the powder bed to a hydrogen-containing gas to reduce the oxides and store the chemical energy of hydrogen; exposing the reduced powder bed to a steam-containing gas to oxidize the metallic components and generate hydrogen; and repeating the alternating redox cycles. During reduction, Sn forms a transient liquid phase that induces a swelling effect, generating and preserving porosity in the powder bed.

In one embodiment, the hydrogen-containing gas comprises pure hydrogen and the steam-containing gas comprises water vapor carried by an inert gas.

In one embodiment, the redox cycle comprises a period of time of hydrogen exposure followed by the period of time of steam exposure.

In one embodiment, during the reduction, voids are formed at locations of former Sn particles.

In one embodiment, liquid Sn reacts with metallic iron to form Fe—Sn intermetallic phases that contribute to volumetric expansion and porosity stabilization.

According to embodiments of the invention, the blend of Fe₂O₃ and SnO₂ powders that, upon chemical redox cycling in a redox reactor, undergo phase changes that preserve structure and reactivity. During hydrogen reduction, SnO₂ reduces to liquid Sn which diffuses through the Fe matrix, creating porosity at former SnO₂/Sn sites. The transient swelling prevents the sintering typically seen in pure Fe powder beds. The method allows prolonged hydrogen cycling performance without capacity degradation and enables system design free from conventional shaping techniques.

Compared to the Fe—W powders technology, the invention uses Sn (density: 7.3 g/cm³) which is much lighter than W (19.4 g/cm³), while also effectively preventing the sintering of Fe powders via a mechanism which is distinct from that operating in Fe—W powders. This approach marks the first application of reversible reduction/oxidation of Sn for redox cycling of Fe, offering a new promising solution for enhancing the cyclability and efficiency of Fe-based hydrogen production systems. The low density of powder blends is beneficial for energy or hydrogen transport from remote areas with no access to electrical grids or pipelines.

A hydrogen storage system and method are provided based on Fe—Sn powder beds that undergo reversible redox cycling. The invention leverages a transient liquid-phase swelling effect induced by tin (Sn) addition to iron oxide (Fe₂O₃) to preserve porosity and suppress densification during extended chemical redox cycling. When exposed alternately to hydrogen and steam at elevated temperatures, the Sn component temporarily melts and diffuses, forming porosity and Fe—Sn intermetallic phases. This swelling mechanism enables stable and high-capacity hydrogen storage over at least 50 redox cycles, achieving up to 261 mL/g H₂ storage. The invention does not require complex shaping methods and offers applications in chemical looping, solar thermochemical water splitting, and CO₂ utilization. Specifically, the invention provides the following technical features and advantages.

Swelling-induced self-foaming behavior: Introducing up to 40 at. % Sn into Fe-based powder beds enables a transient liquid-phase swelling effect during redox cycling, preserving porosity and reactive surface area.

Use of reversible Sn redox couple: Sn/SnO₂ is uniquely suited as an additive, being both redox-reversible under H₂/steam conditions and capable of forming liquid Sn within operational temperature ranges.

Avoidance of complex shaping: The process achieves high porosity and hydrogen capacity without freezing casting or 3D printing, using only simple powder blending.

Durable cyclic hydrogen storage: The system maintains performance over 50 redox cycles, achieving hydrogen capacities up to 261 mL/g, which is about 22× that of pure Fe.

New design strategy: The work introduces a diffusion-mediated porosity design in Fe-based redox materials via the swelling effect and intermetallic formation.

Selective addition ofSn: The inventors identify Sn as uniquely effective among low-melting-point metals for inducing transient liquid-phase swelling while maintaining redox activity under relevant conditions.

Balancing swelling and densification: By tuning Sn content (0.5-40 at. %), the inventors optimize a composition (particularly at 25-40 at. %) that balances expansion from porosity and contraction from oxide reduction.

Durable architecture through cycle regeneration: The system relies on the recurrent formation and oxidation of Sn to regenerate the liquid phase and maintain open porosity, effectively countering sintering over extended redox cycles.

Thermodynamic and microstructural tailoring: Careful thermodynamic analysis and phase monitoring (in situ XRD) were used to ensure that Sn induces desired structural transformations at the correct redox stages.

The invention can be used for various industrial applications including, but not limited to, ammonia production, petroleum refining and biomass gasification; stationary combustion (fuel cells, combustion engines) to produce electricity; capture of CO₂ from flue gases and transformation to CO (for utilization in the chemical industry); chemical looping combustion of methane.

In addition, given its lower mass compared to Fe—W, new applications exist, based on transport: energy transport for electricity produced from off-grid renewable sources (when coupled with a water electrolyzer); use of methane or geological hydrogen to convert oxide powders to metallic powders, allowing road transport from remote areas without access to pipelines; at hub, reconversion from metallic to oxide powders liberates hydrogen, which can be used as a molecules in the chemical industry, or further combusted (fuel cell or combustion engines) to create electricity; and hydrogen storage and release for transportation (especially trains and ships) using fuel cells or combustion engines.

Achieving high cyclability in Fe-based chemical looping for hydrogen storage and production can significantly reduce costs, improve efficiency, and enhance scalability for diverse industrial applications. The addition of Sn to Fe-based chemical looping helps maintain its lightweight advantage, making it well-suited for off-grid and remote renewable energy sources. This enhancement facilitates the efficient utilization of clean energy, contributing to decarbonization efforts and advancing net-zero goals. Furthermore, it enables localized hydrogen production and storage in remote areas, bolstering energy security and supporting sustainable energy solutions.

These and other aspects of the invention are further described below. Without intent to limit the scope of the invention, exemplary instruments, apparatus, methods, and their related results according to the embodiments of the invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### Example

### Self-Foaming Fe—Sn Powder Beds for Durable Hydrogen Storage and Release

Hydrogen storage via metal oxide redox cycling offers a scalable route for capturing intermittent renewable energy, but long-term capacity loss due to sintering and densification remains a major challenge. In this work, we demonstrate that a transient liquid-phase swelling effect, triggered by the addition of an element with low melting point, can effectively preserve porosity and reactive surface area during extended redox cycling. By incorporating up to 40 at. % Sn into Fe-based powder beds, we induce self-foaming behavior that counteracts densification and enables stable hydrogen storage performance over 50 cycles. In situ X-ray diffraction and thermodynamic analysis reveal that both the added Sn and the resulting Fe—Sn intermetallics undergo reversible transformations throughout cycling, helping maintain high hydrogen capacity. Microstructural analysis shows that the continuous formation of porosity at former Sn sites and volumetric expansion of solid particles from imbalanced diffusion contribute to the retention of a porous architecture. This strategy achieves a hydrogen capacity of up to 261 mL/g, which is 22 times higher than that of pure Fe after 50 cycles. It provides a new materials design approach for durable metal oxide systems in hydrogen storage, with other potential applications in solar thermochemical water splitting, carbon dioxide utilization, and chemical looping technologies.

Specifically, we introduce an unexplored compositional design for the redox cycling of iron oxide that enables the formation and retention of a porous morphology through imbalanced diffusion. A reversible Sn element is added in Fe powder beds, facilitating porosity development through a swelling effect during transient liquid sintering. By systematically varying the Sn concentration from 0 to 40 at. %, we reveal its influence on phase evolution, sintering behavior, and morphological transformation during hydrogen reduction and steam oxidation. This diffusion-mediated strategy generates pores at former Sn sites, drives the expansion of Fe-containing particles, and preserves high hydrogen storage capacity through stable and accessible porous structures. As a result, it does not sacrifice specific hydrogen capacity, avoids the formation of chemical vapor phases, and eliminates the need for complex shaping methods such as freeze casting or 3D printing. This study establishes a new pathway for durable hydrogen storage and generation.

### MATERIALS AND METHODS

### Powder Blends and Redox Cycling

Fe₂O₃—SnO₂ powder blends were prepared by mixing Fe₂O₃ (Noah Technologies, 99.9%, <3 μm) and SnO₂ (US Nano Research, 99.7%) using zirconia balls in a ball mill for 24 h with a ball-to-powder weight ratio of 5:1. To achieve specific compositions, varying amounts of SnO₂ powder were added, resulting in Fe-10 at. %/19 wt. % Sn, Fe-25 at. %/41 wt. % Sn, and Fe-40 at. %/59 wt. % Sn blends. Approximately 40 mg of the ball-milled, loosely packed powder blend was weighed and placed into alumina crucibles for redox cycling. These experiments were conducted at 650 °C with a heating rate of 10 °C/min in an alumina tube furnace (inner diameter: 20 mm, length: 500 mm). Pure H₂ gas (UHP, 200 sccm) and steam (H₂O vapor) were alternately introduced into the furnace. Argon gas (UHP, 120 sccm) was used to carry H₂O vapor by passing through a heated deionized water bubbler maintained at 93 °C, creating a water vapor pressure of 770 mbar. Each redox cycle comprised a 90-minute reduction step in H₂ gas, followed by a 90-minute oxidation step in H₂O vapor. After completing the assigned redox cycles, the samples were cooled to room temperature at a rate of about 5 °C/min. Reduced samples were cooled under 100 sccm H₂, while oxidized samples were cooled under 20 sccm of Ar-4% H₂.

### Characterization

In-situ X-ray diffraction with an Ag source was performed on STADI MP on a Fe₂O₃— SnO₂ powder blend (target composition: Fe-40 Sn) lodged in a quartz capillary (1.0 mm ID, 1.2 mm OD). This powder-loaded capillary is placed into a larger externally-heated quartz capillary (1.5 mm ID, 1.8 mm OD, 165 mm length) with quartz wool and ceramic rods positioning and securing the powder-loaded capillary in the center. Diffraction data were collected over a 2θ coverage of 18.5° during a 90 s exposure, with 5 °C steps during heating from 100 to 650 °C, with a heating rate of 10 °C/min under a pure hydrogen (UHP) flow 20 sccm/min. The 650 °C temperature was maintained for 90 min and the atmosphere switched to steam (H₂O vapor) at 1 minute with argon (UHP) was used to carry H₂O vapor, creating about 1 bubble per second while venting downstream. After the 90 min oxidation, the atmosphere was switched to pure H₂ (20 sccm) and the temperature was maintained at 650 °C for another 90 min. The ex-situ X-ray diffraction was performed after cooling to ambient temperature, on cross-sections of sintered samples, using a Smartlab 3 kW Gen2 diffractometer.

Metallographic characterization was done on surface or polished cross-sections of samples which were cold mounted in epoxy resin, ground with SiC grinding papers, polished with diamond suspensions (3 and 1 μm) and colloidal silica (0.05 μm). Optical micrographs were taken using a stereo microscope and scanning electron microscopy (SEM) was performed on a Quanta 650 instrument, after coating the samples with 4-8 nm Os.

### RESULTS AND DISCUSSION

### Swelling Effect

When a liquid phase forms temporarily and disappears after sufficient diffusion during sintering, the process is transient liquid-phase sintering. This phenomenon can result in either densification (pore elimination) or swelling (pore formation or foaming), depending primarily on the solubility ratio S_{R}:

$${S}_{R} = \frac{{S}_{SL}}{{S}_{LS}}$$

where the S_{SL} is the solubility of the solid phase (high melting element) in the liquid phase, and the S_{LS} is the solubility of the liquid phase (low melting element) in the solid phase. When S_{R}>1, the liquid tends to dissolve and reprecipitate the solid, facilitating rearrangement and densification, as observed in systems such as W—Fe and Fe—Ti. In contrast, when S_{R}<1, transient liquid-phase sintering tends to induce a swelling effect. In this case, the liquid phase diffuses into the solid particles, leaving behind pores at the former liquid sites. This behavior has been observed in systems such as Al—Zn, Cu—Sn, Fe—Al, where Zn—, Sn—, and Al-rich liquids exhibit low solubility ratios. Although swelling has traditionally been considered undesirable in powder metallurgy due to its difficulties with densification, this phenomenon can be leveraged to engineer porous structures with high surface area. Such porosity is advantageous not only for metal oxide-based hydrogen storage systems but also for applications in solar thermal water splitting, carbon dioxide utilization, and chemical looping combustion.

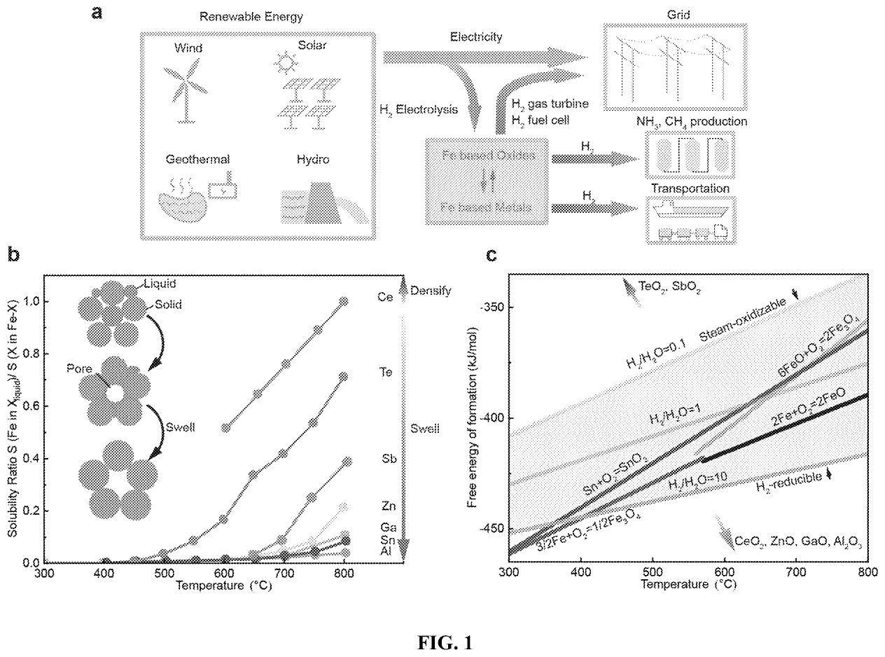

To harness the transient liquid-phase swelling effect, the added metal element must either melt or form a eutectic liquid at relatively low temperatures, prior to significant densification of the base metal of Fe. Therefore, alloying elements capable of forming a liquid phase between 300-800 °C and exhibiting a low solubility ratio S_{R} (defined as S_{Fe in liquid X-Fe}/S_{X in Fe-X}) are summarized in panel (b) of FIG. 1. For simplicity, S_{X in Fe—X} refers to either the solubility of the liquid phase in the Fe solid solution or the concentration of X in the X-richest intermetallic phase, which is adjacent to the liquid phase lines in the phase diagrams. Elements such as Ce, Te, Sb, Zn, Ga, Sn, and Al exhibit low values under the operating conditions of Fe-based redox cycling and are thus favorable for the swelling effect. Notably, the Fe—Al and Fe—Sn systems have solubility ratios below 0.1, ensuring the occurrence of the swelling effect.

In addition to forming a transient liquid phase for the swelling effect, the added elements must exhibit reversible redox behavior under hydrogen and steam to enable high specific hydrogen capacity and volumetric energy density. As shown in the Ellingham diagram (panel (c) of FIG. 1), the Gibbs free energy of formation for H₂O is plotted for three partial pressure ratios of H₂ to H₂O (P_{H2}/P_{H2O})=0.1, 1, and 10. The lines corresponding to P_{H2}/P_{H2O}=0.1 and 10 are used as thermodynamic boundaries for selecting metal/metal oxide pairs suitable for redox cycling. Oxides that lie below the P_{H2}/P_{H2O}=0.1 line are thermodynamically favored to form in steam, indicating that the corresponding metals can be oxidized to generate H₂. Conversely, oxides above the P_{H2}/P_{H2O}=10 line can be reduced by H₂, as steam is more stable under those conditions. Fe₃O₄ and FeO fall within these two boundaries, enabling their reversible redox behavior and making them well-suited for hydrogen storage and production applications.

However, several potential candidates for the swelling effect are excluded due to their poor redox reversibility. Specifically, Te and Sb are difficult to oxidize in steam, while CeO₂, ZnO, GaO, and Al₂O₃ are not reduced by hydrogen under typical operating conditions. Among the candidates considered, only the Sn/SnO₂ redox pair lies within the thermodynamic window defined by the P_{H2}/P_{H2O}=0.1 and 10 boundaries (panel (c) of FIG. 1), demonstrating reversible behavior during both hydrogen reduction and steam oxidation. Pure Sn/SnO₂ systems have previously been utilized for hydrogen production, solar thermal water splitting, carbon dioxide utilization. However, pure liquid Sn tends to coalesce due to surface tension, leading to agglomeration and loss of reactive surface area. Here, Sn/SnO₂ is selected as a minor element that enables the swelling effect and maintains high surface area in Fe powder beds for efficient redox cycling.

### Phase Evolution

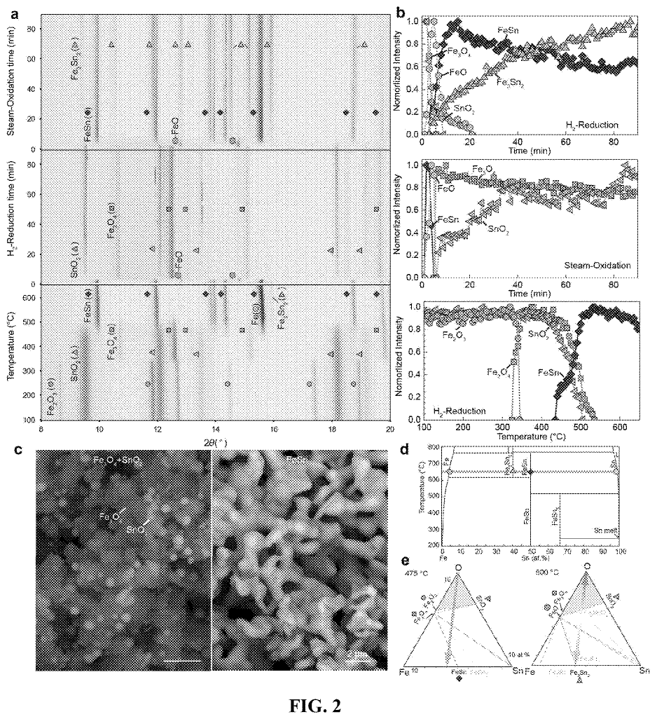

The phase evolution of a Fe₂O₃—SnO₂ powder blend, designed to yield Fe-40 at. % Sn upon reduction, is first investigated using in situ X-ray diffraction during sequential steam oxidation and H₂ reduction. As shown in panels (a)-(b) of FIG. 1, the phase transitions were monitored across three stages: (bottom) H₂ reduction from 100 to 650 °C, (middle) steam oxidation at 650 °C for 90 minutes, and (top) a second H₂ reduction at 650 °C for 90 minutes. During the initial H₂ reduction stage (100-650 °C), Fe₂O₃ partially reduces to Fe₃O₄ beginning at 330 °C, completing the transition by 345 °C. The reduction of SnO₂ begins at 420 °C and completes at 505 °C, forming liquid Sn, which is not detectable by XRD due to its lack of crystallinity. No intermediate oxide phases of Sn (e.g., SnO, Sn₂O₃, Sn₃O₄) were detected. Subsequently, Fe₃O₄ is reduced to metallic Fe, which reacts with liquid Sn to form the FeSn intermetallic phase, starting at 440 °C and completing by 535 °C. This indicates that the swelling effect induced by the formation of liquid Sn begins at approximately 440 °C. The total reduction of the Fe₃O₄—SnO₂ powder blend is complete at 535 °C, suggesting that this is the minimum operating temperature required for complete H₂ reduction, and redox cycling below this threshold is not viable. Previously, the Fe and Sn were steam oxidized separately at 550 °C. The kinetics of Sn oxidation at this temperature are limited, with only about 34% of Sn oxidized after 90 minutes. In contrast, the oxidation rate improves significantly at 650 °C. Therefore, the temperature continues to ramp to 650 °C for enhanced reaction kinetics. The reduction sequence follows the arrowhead guideline shown in the ternary Fe—Sn—O phase diagram at 475 °C (panel (e) of FIG. 2). The FeSn₂ phase is not observed because SnO₂ is predominantly reduced at temperatures above 475 °C.

The H₂-reduced Fe—Sn sample was subjected to steam oxidation at 650 °C by switching the gas atmosphere to steam at 1 minute. The FeSn phase began to decompose at 2 minutes, forming FeO and liquid Sn. By 6 minutes, the FeO phase was fully converted to Fe₃O₄, and the formation of SnO₂ began at approximately 7 minutes. The evolution of these phases generally follows the arrowhead guideline in the Fe—Sn—O ternary phase diagram at 800 °C (panel (e) of FIG. 2), with the exception of Fe₅Sn₃ and Fe₂SnO₄ (gray color), which are not thermodynamically stable at 650 °C. The reformation of Fe₃O₄ and SnO₂, rather than ternary oxides, after steam oxidation, suggests that the swelling effect associated with reduced liquid Sn can reoccur in the subsequent reduction step. This consistent regeneration of liquid Sn supports the durability of the swelling effect across multiple redox cycles, enabling stable hydrogen storage and release. Following initial decomposition and oxidation, Fe₃O₄ reaches its maximum normalized XRD intensity, indicating fast oxidation kinetics of Fe and FeO at this temperature. In contrast, the normalized intensity of SnO₂ continues to increase steadily from 7 to 90 minutes, suggesting a slower oxidation rate for liquid Sn compared to Fe. The subsequent slight decrease in Fe₃O₄ intensity could result from increased X-ray absorption by the growing SnO₂ phase, which contains more oxygen atoms and may attenuate the transmitted X-rays more strongly than the liquid Sn phase.

In the final stage, the steam-oxidized Fe₃O₄—SnO₂ samples are subjected to H₂ reduction at 650 °C by switching the gas atmosphere to H₂ at 1 minute. Fe₃O₄ begins to partially reduce to FeO at 2 minutes and is fully reduced by 6 minutes. Simultaneously, SnO₂ begins to reduce to liquid Sn at 2 minutes and is fully reduced by 9 minutes, indicating a slower reduction kinetics for SnO₂ compared to Fe₃O₄. The FeO phase reached its maximum intensity at 5 minutes and is completely reduced to metallic Fe by 21 minutes. The nascent Fe immediately reacted with liquid Sn to form FeSn and Fe₃Sn₂ intermetallic phases. This reduction sequence aligns again with the arrowhead guideline indicated in the Fe—Sn—O ternary phase diagram at 800 °C (panel (e) of FIG. 2). At later stages, the normalized intensity of FeSn decreases while that of Fe₃Sn₂ increases, suggesting a reaction pathway in which liquid Sn initially forms FeSn upon contact with Fe, followed by further diffusion of Sn into Fe to produce Fe₃Sn₂.

The surface morphology of the steam-oxidized and H₂-reduced Fe-40 at. % Sn powder blend is shown in panel (c) of FIG. 2. Submicron-sized SnO₂ particles are observed, exhibiting near-spherical morphology. This shape suggests that the precursor liquid Sn has a high contact angle on the Fe₃O₄ surface. Liquid Sn exhibits poor wetting on oxidized Fe surfaces, with a contact angle of approximately 90°, whereas good wetting is observed on cleaner Fe surfaces, with the contact angle decreasing to around 250 after sufficient time at 400 °C. When a liquid phase forms between two closely spaced solid particles, a high contact angle tends to push the particles apart by capillary forces, particularly in systems with a high-volume fraction of such liquid phase. Thus, in addition to the swelling effect of Sn during the reduction stage, the high contact angle of liquid Sn on the oxide surface also contributes to the stabilization of the porous microstructure. After reduction, a porous FeSn intermetallic phase is observed on the surface, further confirming the preservation of structural porosity.

### Redox Cycling of Fe—Sn

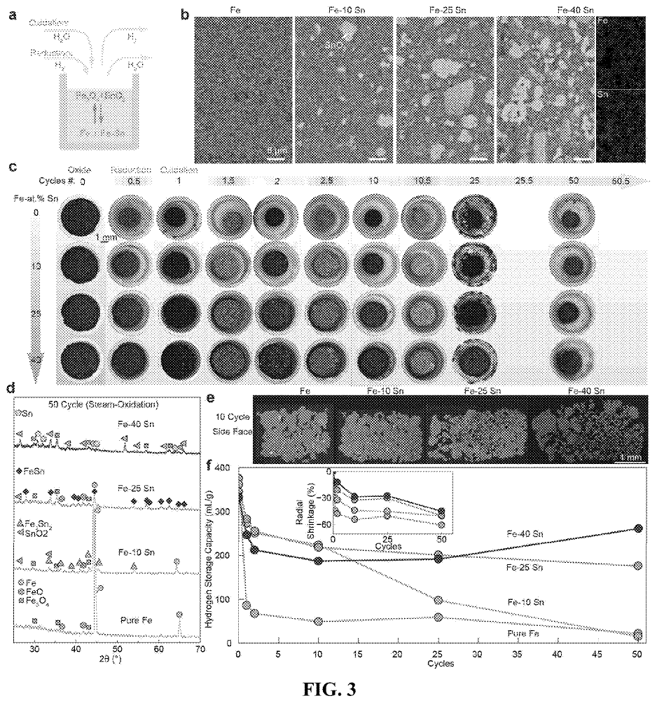

Powder beds composed of Fe₂O₃ and SnO₂ were mixed and loaded into alumina crucibles, then subjected to H₂ reduction at 650 °C for 90 minutes to store chemical energy, followed by steam oxidation at 650 °C for 90 minutes to release H₂, as illustrated in panel (a) of FIG. 3. The swelling effect of Sn in the Fe-based powder bed was investigated by varying Sn content from 0 to 40 at. % (panel (b) of FIG. 3). Initially, all four oxide powder beds have diameters defined by the inner diameter of the crucibles (panel (c) of FIG. 3). After the initial H₂ reduction (0.5 cycle), the oxide blends were transformed into Fe and Fe—Sn intermetallic phases (Fe₃Sn₂ and FeSn). Oxygen removal during reduction causes particle shrinkage, and when combined with sintering, this leads to densification and a loss of reactive surface area. For the pure Fe sample, a significant radial shrinkage of −43.4% was observed, indicating severe densification and reduced surface areas. In contrast, the addition of SnO₂ effectively mitigated this shrinkage. Fe-10 at. % Sn, Fe-25 at. % Sn, and Fe-40 at. % Sn samples exhibited reduced shrinkages of −31.3%, −20.9%, and −14.3%, respectively. These results demonstrate that increasing Sn content enhances the swelling effect, which counteracts densification and helps preserve reactive surfaces. The trend aligns with previous observations in Al—Zn and Cu—Sn powder sintering systems, where higher Zn or Sn content promotes more pronounced swelling due to increased liquid-depletion porosity and volumetric expansion of solid particles, arising from imbalanced diffusion between liquid and solid phases. For the Fe-40 at. % Sn sample, the relatively small shrinkage (absolute value) is attributed to a balance between the volume contraction caused by oxide-to-metal reduction and the expansion from the swelling effect during Fe—Sn powder sintering. Following H₂ reduction, the samples were subjected to steam oxidation (1 cycle). The steam-oxidized pure Fe sample shows a linear shrinkage of −44.2%, similar to that after the initial reduction. In contrast, the Fe-10 at. %, Fe-25 at. %, and Fe-40 at. % Sn samples showed reduced shrinkages of −29.7%, −19.9%, and −12.0%, respectively. These reduced absolute shrinkage values, compared to the initial reduced state, suggest that there is a volume expansion from oxygen uptake. It is enabled by the preserved porosity and high reactive surface area, which promote faster oxidation and volume expansion from their reduced states.

Cross-sectional (side view) SEM images of the reduced powder beds after 10.5 redox cycles are shown in panel (e) of FIG. 3. The Fe-10 at. % Sn, Fe-25 at. % Sn, and Fe-40 at. % Sn samples display similar or slightly greater heights compared to the pure Fe powder bed. Notably, the vertical height remains relatively similar, in contrast to the significantly different shrinkage observed in the radial direction. This anisotropic shrinkage is likely attributed to the downward flow and rearrangement of particles induced by the transient liquid phase under the influence of gravity. However, when considering the radial shrinkage, these results confirm that the addition of Sn effectively suppresses densification and shrinkage during redox cycling.

Extended redox cycling up to 50 cycles was conducted, and the corresponding radial shrinkage is presented in panel (f) of FIG. 3. All four compositions exhibit gradual increases in absolute shrinkage over repeated cycles, primarily due to cumulative sintering effects. However, powder beds containing higher Sn content show reduced shrinkage compared to those with lower or no Sn. After 50 cycles, the Fe-40 at. % Sn sample exhibits the smallest absolute radial shrinkage at −45.0%, in contrast to −60.5% for pure Fe, −50.1% for Fe-10 at. % Sn, and −49.8% for Fe-25 at. % Sn, suggesting that the incorporation of Sn effectively mitigates sintering-induced densification during long-term cycling.

XRD patterns after 50 redox cycles are shown in panel (d) of FIG. 3. For the pure Fe sample, the diffraction peaks are dominated by metallic Fe (87.7 vol. %), with minor contributions from FeO (7.8 vol. %) and Fe₃O₄ (4.5 vol. %). The predominance of unoxidized metallic Fe indicates limited participation in redox reactions and corresponds to the observed low hydrogen storage capacity. In the Fe-10 at. % Sn sample, metallic Fe remains the dominant phase (82.2 vol. %), accompanied by small fractions of Fe₃O₄ (5.2 vol. %), SnO₂ (2.9 vol. %), and Fe₃Sn₂ intermetallic (9.7 vol. %), suggesting that only a limited portion of the material contributes to hydrogen generation. The phase composition of the Fe-25 at. % Sn sample shifts significantly, with a higher fraction of oxide phases: Fe₃O₄ (47.2 vol. %) and FeO (21.5 vol. %). The remaining metallic phases include FeSn (19.5 vol. %) and Fe (11.8 vol. %), indicating greater participation in redox reactions compared to lower Sn content samples. For the Fe-40 at. % Sn sample, oxide formation is even more pronounced, with Fe₃O₄ accounting for 74.9 vol. % and SnO₂ for 8.5 vol. %. A residual metallic Sn phase (16.6 vol. %) remains consistent with its slower steam oxidation kinetics, as previously observed in panels (a)-(b) of FIG. 2.

The hydrogen storage capacity of the powder beds was evaluated based on weight change measurements over cycles 1-10 and XRD phase quantification at cycles 25 and 50, as shown in panel (f) of FIG. 3. As the Sn content increases, the initial hydrogen capacity per gram of powder decreases due to the higher molar mass of Sn compared to Fe. During redox cycling, the hydrogen capacity of pure Fe declines rapidly, stabilizing at a low value after just two cycles. With the addition of 10 at. % Sn, the powder bed maintains a hydrogen capacity above 224 mL g⁻¹ during the first 10 cycles. However, by cycles 25 and 50, the capacity drops to 15 mL g⁻¹, comparable to that of pure Fe, suggesting that the porosity generated by the swelling effect of Sn is gradually lost due to long-term sintering. In contrast, the Fe-25 at. % Sn sample exhibits improved long-term stability, maintaining a capacity of 176 mL g⁻¹ after 50 cycles. This suggests that the competing effects of swelling-induced porosity and sintering reach a quasi-equilibrium. The highest performance is observed for the Fe-40 at. % Sn composition, which achieves a hydrogen capacity of 261 mL g⁻¹, approximately 22 times higher than that of pure Fe. These results demonstrate that leveraging the swelling effect of transient liquid Sn during redox cycling is an effective strategy for enhancing the hydrogen storage performance of Fe-based powder beds.

### Microstructural Evolution

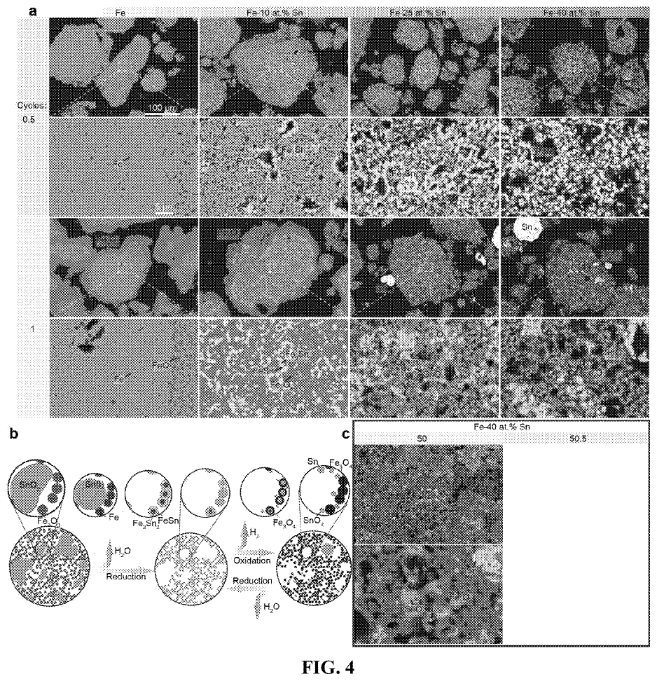

Cross-sectional microstructures of Fe, Fe-10 at. % Sn, Fe-25 at. % Sn, and Fe-40 at. % Sn powder beds after the first H₂ reduction (0.5 cycle) and subsequent steam oxidation (1 cycle) are shown in panel (a) of FIG. 4. Following H₂ reduction, all compositions form agglomerates due to necking between loosely packed powders. However, the internal microstructures of these agglomerates vary significantly depending on composition. The pure Fe sample exhibits the most densified microstructure, attributed to rapid sintering kinetics that promote substantial densification. In contrast, the Fe-10 at. % Sn sample shows a less dense structure characterized by two distinct pore types. The first is liquid-depletion pores located at former Sn sites, typically surrounded by a bright Fe₃Sn₂ intermetallic phase formed via reactions between Fe and adjacent liquid Sn. The second type consists of pores distributed within the Fe matrix, resulting from reduced particle connectivity and slower densification induced by the presence of porosity. In the Fe-25 at. % Sn sample, the number of liquid-depletion pores increases, and the Fe matrix becomes even more porous. This enhanced porosity arises not only from the liquid-depletion porosity and slowed densification but also from the volumetric expansion associated with the formation of Fe—Sn intermetallic phases, which absorb liquid Sn during reduction. The Fe-40 at. % Sn composition exhibits the most porous microstructure, driven by a combination of extensive liquid-depletion porosity formation, reduced sintering kinetics, and significant particle growth due to intermetallic formation.

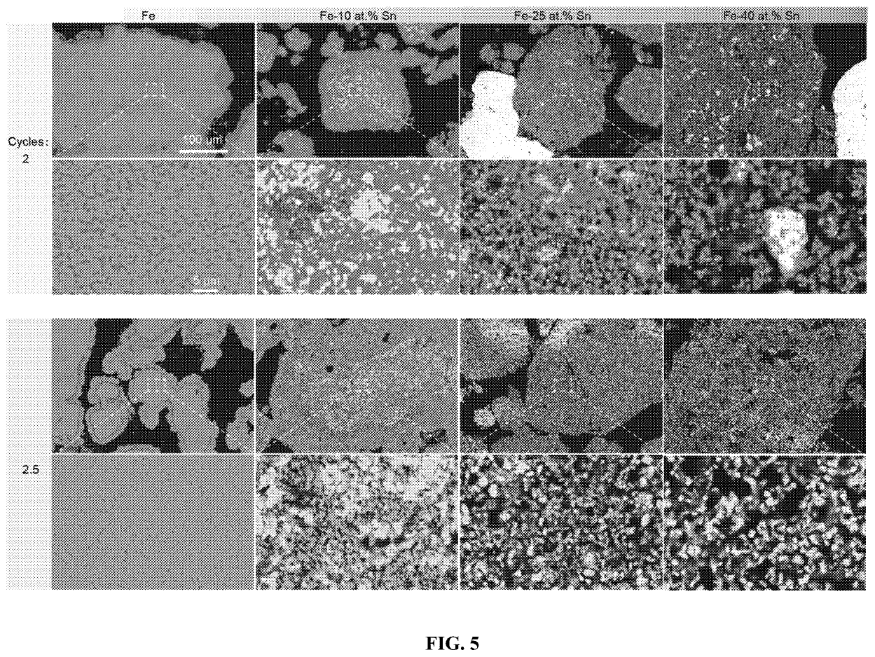

After the first steam oxidation cycle, pure Fe samples develop a Fe₃O₄ shell on the surface of the agglomerates, while the internal core largely remains in a metallic state. This unreacted core is not accessible to steam and therefore does not contribute to hydrogen generation within the reaction time. The rapid loss of reactive surface area severely limits the utilization of metallic Fe in subsequent redox cycles. As a result, redox reactions in pure Fe samples are confined primarily to the oxide shell regions, as illustrated in FIGS. 5-7, with only a small portion of the material participating in the redox process. Consequently, the hydrogen capacity of pure Fe powder declines sharply within the first two cycles and then stabilizes at a low level, as shown in panel (f) of FIG. 3.

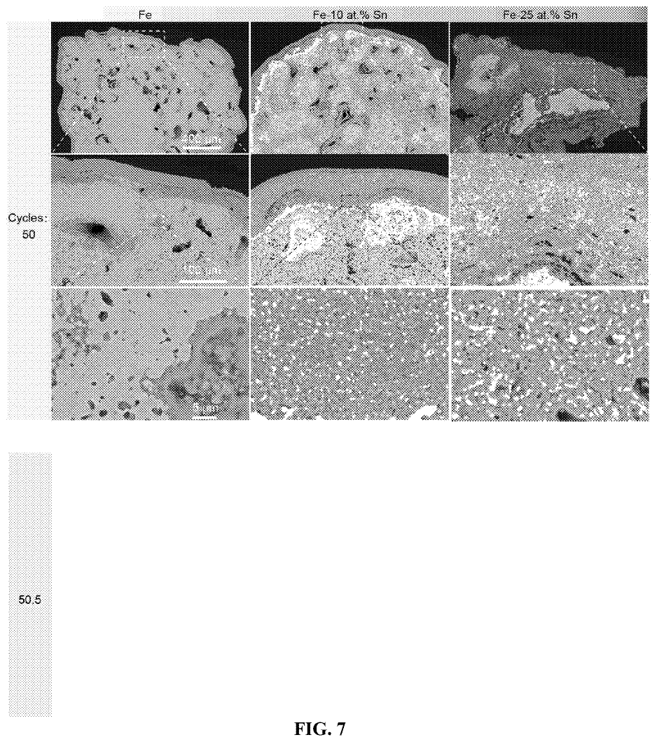

When 10 at. % Sn is added to the Fe powder bed, a Fe₃O₄ shell forms on the surface of the agglomerates, while the internal microstructure becomes enriched with Sn-rich phases. This morphology results from the slower oxidation kinetics of Sn compared to Fe. As Fe oxidizes more rapidly, liquid Sn is expelled and migrates inward, where it reacts with unoxidized Fe to form intermetallic phases. Notably, Fe₃O₄ is observed within the agglomerates instead of residual metallic Fe, indicating that a greater fraction of the material participates in hydrogen generation. This explains the relatively high hydrogen capacity observed in Fe-10 at. % Sn samples during the initial redox cycles. liquid-depletion porosity and pores retained due to slowed densification maintain open channels that allow steam to penetrate and react with internal metallic phases. However, some Sn-rich intermetallics remain unoxidized as they become encapsulated by the rapidly forming Fe₃O₄ shell and lose access to steam. The microstructure remains largely unchanged through 10 cycles (FIGS. 5-7), but undergoes significant degradation after extended cycling. By 50 cycles (FIG. 7), the big agglomerates have coalesced, and steam oxidation occurs primarily at the outer surface of the whole powder bed. This structural collapse leads to a substantial drop in hydrogen capacity, approaching that of pure Fe samples (panel (f) of FIG. 3).

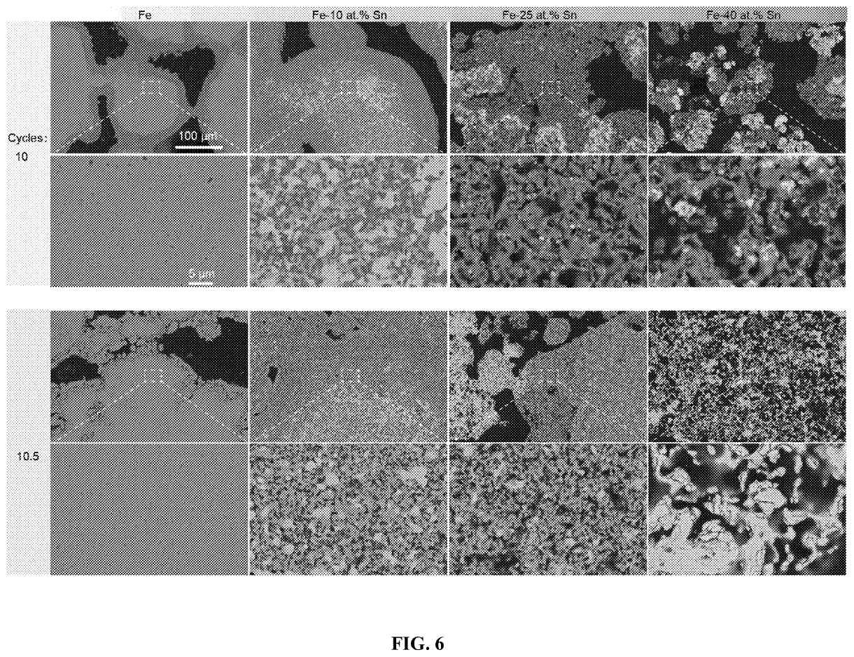

The steam-oxidized Fe-25 at. % Sn sample retains a porous microstructure within the agglomerates without the formation of a dense Fe₃O₄ shell as seen in the Fe-10 at. % Sn composition. Both Fe₃O₄ and SnO₂ phases are observed within the agglomerates, enabled by open porosity that promotes efficient steam access and accelerated oxidation. In addition, near-spherical metallic Sn particles are observed outside the agglomerates. These are formed via liquid-phase migration, driven by the high contact angle of liquid Sn on the Fe₃O₄ surface, and remain unoxidized due to their limited surfaces for oxidation. After 10 redox cycles, the sample maintains a porous microstructure (FIG. 6), but becomes relatively denser after 50 cycles (FIG. 7). The oxidized samples at this stage consist of a Fe₃O₄-rich outer shell encompassing a Sn-rich intermetallic core, which is shielded from steam and therefore difficult to oxidize. This observation is consistent with the presence of the FeSn phase, as identified by XRD after steam oxidation, as shown in panel (d) of FIG. 3.

Among the tested compositions, the Fe-40 at. % Sn sample exhibits the most porous microstructure after steam oxidation, driven by the pronounced swelling effect associated with its high Sn content. Within the agglomerates, Fe₃O₄ particles remain well isolated, providing an abundance of reactive surfaces for subsequent redox reactions. In addition to uniformly distributed submicron-sized SnO₂ particles, larger aggregates of SnO₂ are also observed. These are attributed to the relatively slow steam oxidation kinetics of Sn, where the transient liquid Sn phase can flow and coalesce prior to full oxidation, resulting in large SnO₂ particles. Furthermore, large, near-spherical metallic Sn particles are also found outside the Fe₃O₄-rich agglomerates. Over repeated redox cycling (FIGS. 5-7), the Fe-40 at. % Sn sample consistently maintains the most porous microstructure among all compositions, even after 50 cycles (panel (c) of FIG. 4), highlighting its superior microstructural stability in maintaining abundant reactive surfaces. The evolution of this microstructure is schematically illustrated in panel (b) of FIG. 4. Porosity arises from a combination of liquid-depletion void formation at former Sn sites, volumetric expansion of solid phases, and suppressed sintering due to reduced interparticle connectivity. During each steam oxidation step, Fe and Sn separate from their intermetallic state and convert into Fe₃O₄ and SnO₂/Sn, respectively, allowing the swelling effect to persist after reduction and remain effective in subsequent redox cycles.

In sum, this disclosure presents the first utilization of the swelling effect for redox cycling of metal oxides. The findings offer a new pathway to enhance the cyclability and efficiency of Fe-based systems for hydrogen production and storage. Introducing reversible Sn/SnO₂ into the Fe powder bed effectively preserves highly reactive surface areas over repeated redox cycles. This compositional design strategy can be broadly applied to engineer porous microstructures in other materials, especially for solar thermal water splitting, carbon dioxide utilization, and chemical looping combustion technologies.

The core novelty of this invention lies in the use of an Fe—Sn powder blend to overcome the rapid sintering and loss of reactive surface area that typically plagues iron-based materials during high-temperature chemical looping for hydrogen storage. Specifically, the invention leverages a “transient liquid-phase sintering induced swelling effect.” When the Fe—Sn powder blend is subjected to hydrogen reduction at elevated temperatures (e.g., 300-800 °C), the tin component temporarily melts and diffuses. Instead of causing the densification typically seen in liquid-phase sintering, this transient liquid phase induces a unique swelling effect. This generates and preserves a highly porous microstructure through a combination of void formation at former Sn sites, volumetric expansion from the formation of Fe—Sn intermetallic phases, and reduced solid-solid particle connectivity.

The inventive step is the non-obvious selection and application of Sn as a redox-active additive to solve the sintering problem in Fe-based hydrogen storage. Prior art solutions relied on adding inert powders (which dilute hydrogen capacity), heavy refractory metals like Tungsten or Molybdenum (which add prohibitive weight and can form volatile phases), or complex, expensive mechanical structuring like freeze-casting or 3D printing. The inventors recognized that Sn is uniquely suited because it possesses a low solubility ratio in solid Fe (driving swelling rather than densification), a low melting point, and crucially, it is fully redox-reversible under H₂/steam conditions. This allows the Fe—Sn blend to maintain stable, high-capacity hydrogen storage (up to 261 mL/g) over at least 50 redox cycles using simple powder blending, entirely avoiding the need for complex shaping techniques while remaining lightweight enough for practical transport and off-grid applications.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described to explain the principles of the invention and their practical application to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications, and various publications, are cited and discussed in the description of this invention. The citation and/or discussion of such references is provided merely to clarify the description of the invention and is not an admission that any such reference is “prior art” to the invention described herein. All references cited and discussed in this specification are incorporated herein by reference in their entireties and to the same extent as if each reference was individually incorporated by reference.

### LIST OF REFERENCES

[1]. Allendorf M D, et al. Challenges to developing materials for the transport and storage of hydrogen. Nature Chemistry 14, 1214-1223 (2022).
[2]. Zeng L, Cheng Z, Fan J A, Fan L-S, Gong J. Metal oxide redox chemistry for chemical looping processes. Nature Reviews Chemistry 2, 349-364 (2018).
[3]. Debiagi P, Rocha R C, Scholtissek A, Janicka J, Hasse C. Iron as a sustainable chemical carrier of renewable energy: Analysis of opportunities and challenges for retrofitting coal-fired power plants. Renewable and Sustainable Energy Reviews 165, 112579 (2022).
[4]. Chen M, Pennell S, Dunand D C. Tungsten's Role in Enhancing Sintering Resistance of Fe—W Hierarchical Foams during Redox Cycling. Adv Funct Mater 34, 2411085 (2024).
[5]. Green ammonia synthesis. Nature Synthesis 2, 581-582 (2023).
[6]. Vogt C, Monai M, Kramer G J, Weckhuysen B M. The renaissance of the Sabatier reaction and its applications on Earth and in space. Nature Catalysis 2, 188-197 (2019).
[7]. Wei S, Ma Y, Raabe D. One step from oxides to sustainable bulk alloys. Nature 633, 816-822 (2024).
[8]. Nazir H, et al. Is the H2 economy realizable in the foreseeable future?Part III: H2 usage technologies, applications, and challenges and opportunities. Int J Hydrogen Energy 45, 28217-28239 (2020).
[9]. Drenckhahn W W, et al. A Novel High Temperature Metal−Air Battery. ECS Transactions 50, 125 (2013).
[10]. Berger C M, et al. Development of storage materials for high-temperature rechargeable oxide batteries. Journal of Energy Storage 1, 54-64 (2015).
[11]. Fang Q, Berger C M, Menzler N H, Bram M, Blum L. Electrochemical characterization of Fe-air rechargeable oxide battery in planar solid oxide cell stacks. J Power Sources 336, 91-98 (2016)
[12]. Trocino S, Lo Faro M, Zignani S C, Antonucci V, Arico A S. High performance solid-state iron-air rechargeable ceramic battery operating at intermediate temperatures (500-650 °C). Applied Energy 233-234, 386-394 (2019).
[13]. Wilke S K, Dunand D C. Structural evolution of directionally freeze-cast iron foams during oxidation/reduction cycles. Acta Mater 162, 90-102 (2019).
[14]. Leonide A, Drenckhahn W, Greiner H, Landes H. Long Term Operation of Rechargeable High Temperature Solid Oxide Batteries. J Electrochem Soc 161, A1297 (2014).
[15]. Muhich C L, et al. Efficient Generation of H<sub>2</sub>by Splitting Water with an Isothermal Redox Cycle. Science 341, 540-542 (2013).
[16]. Mao Y, et al. Hydrogen production via a two-step water splitting thermochemical cycle based on metal oxide—A review. Applied Energy 267, 114860 (2020).
[17]. Muhich C L, et al. Predicting the solar thermochemical water splitting ability and reaction mechanism of metal oxides: a case study of the hercynite family of water splitting cycles. Energy & Environmental Science 8, 3687-3699 (2015).
[18]. Bui M, et al. Carbon capture and storage (CCS): the way forward. Energy & Environmental Science 11, 1062-1176 (2018).
[19]. Pennell S, Dunand D C. Microstructural evolution of Fe-25 W powder beds during C02-H2 redox cycling at 800 °C. Chem Eng J 497, 154984 (2024).
[20]. Zhu X, Imtiaz Q, Donat F, Müller C R, Li F. Chemical looping beyond combustion—a perspective. Energy & Environmental Science 13, 772-804 (2020).
[21]. Metcalfe I S, et al. Overcoming chemical equilibrium limitations using a thermodynamically reversible chemical reactor. Nature Chemistry 11, 638-643 (2019).
[22]. Wang X, et al. Hydrogen Production by Biomass Model Syngas Chemical Looping over Ce/Zr Doped NiFe204 Oxygen Carrier. Energy Fuels 39, 5907-5918 (2025).
[23]. Chung C, Qin L, Shah V, Fan L-S. Chemically and physically robust, commercially-viable iron-based composite oxygen carriers sustainable over 3000 redox cycles at high temperatures for chemical looping applications. Energy & Environmental Science 10, 2318-2323 (2017).
[24]. Wilke S K, Lundberg R A, Dunand D C. Hierarchical Structural Changes During Redox Cycling of Fe-Based Lamellar Foams Containing YSZ, CeO2, or ZrO2. ACS Appl Mater Interfaces 12, 27190-27201 (2020).
[25]. Wang S, Wang G, Jiang F, Luo M, Li H. Chemical looping combustion of coke oven gas by using Fe2O3/CuO with MgAl2O4 as oxygen carrier. Energy & Environmental Science 3, 1353-1360 (2010).
[26]. Mack J B, Pennell S M, Dunand D C. Sintering inhibition enables hierarchical porosity with extreme resistance to degradation during redox cycling of Fe—Mo foams. Acta Mater 254, 119015 (2023).
[27]. Otsuka K, Kaburagi T, Yamada C, Takenaka S. Chemical storage of hydrogen by modified iron oxides. J Power Sources 122, 111-121 (2003).
[28]. Pennell S, Chen M, Dunand D C. Tungsten Strongly Inhibits Sintering of Porous Iron During High-Temperature Redox Cycling. Small 20, 2402174 (2024).
[29]. Schulmeyer W V, Ortner H M. Mechanisms of the hydrogen reduction of molybdenum oxides. Int J Refract Met Hard Mater 20, 261-269 (2002).
[30]. Haubner R, Schubert W, Hellmer H, Lassner E, Lux B. Mechanism of technical reduction of tungsten. Pt. 2. Hydrogen reduction of tungsten blue oxide to tungsten powder. Int J Refract Hard Met; (United Kingdom) 2, (1983).
[31]. Pennell S M, Chappuis B, Carpenter J A, Dunand D C. Hierarchically Porous Iron Alloys with High Sintering Resistance During Cyclic Steam Oxidation and Hydrogen Reduction. Adv Funct Mater 33, 2307470 (2023).
[32]. German R M. Initial Stage Processes: Solubility and Rearrangement. In: Liquid Phase Sintering). Springer U S (1985).
[33]. Chen S, Jiang Z, Huang J, Yang J, Ye Z. Activated sintering effect of Fe element on tungsten via spark plasma sintering. Nuclear Materials and Energy 32, 101226 (2022).
[34]. German R M, Dunlap J W. Processing of iron-titanium powder mixtures by transient liquid phase sintering. Metall Trans A 17, 205-213 (1986).
[35]. Savitskii A P, Burtsev N N, Martsunova L S. Volume changes experienced by Al—Zn compacts during liquid-phase sintering. Soviet Powder Metallurgy and Metal Ceramics 21, 760-764 (1982).
[36]. Savitskii A P, Emel'yanova M A, Burtsev N N. Volume changes experienced by Cu—Sn compacts during liquid-phase sintering. Soviet Powder Metallurgy and Metal Ceramics 22, 989-992 (1983).
[37]. Chen G, Liss K-D, Chen C, He Y, Qu X, Cao P. Porous FeAl alloys via powder sintering: Phase transformation, microstructure and aqueous corrosion behavior. J Mater Sci Technol 86, 64-69 (2021).
[38]. Spacil H. Hydrogen production by dissociation of steam with liquid tin.). Google Patents (1974).
[39]. Levêque G, Abanades S, Jumas J-C, Olivier-Fourcade J. Characterization of Two-Step Tin-Based Redox System for Thermochemical Fuel Production from Solar-Driven CO2 and H2O Splitting Cycle. Ind Eng Chem Res 53, 5668-5677 (2014).
[40]. Zhao X, Gong Y, Li X, Xu N, Huang K. Performance of Solid Oxide Iron-Air Battery Operated at 550 °C J Electrochem Soc 160, A1241 (2013).
[41]. Raghavan V. Phase diagrams of ternary iron alloys. Indian Institute of Metals (1989).
[42]. Protsenko P, Terlain A, Traskine V, Eustathopoulos N. The role of intermetallics in wetting in metallic systems. Scripta Mater 45, 1439-1445 (2001).
[43]. Hwang K S, German R M, Lenel F V. Capillary forces between spheres during agglomeration and liquid phase sintering. Metall Trans A 18, 11-17 (1987).
[44]. Mack, Jacob Benjamin, Samuel Mark Pennell, and David C. Dunand. “Refractory alloyed iron-based redox active foams for iron-air batteries, fabricating methods and applications of same.” U.S. patent application Ser. No. 18/367,019.
[45]. Pennell, Samuel, and David C. Dunand. “Microstructural evolution of Fe-25 W powder beds during CO2-H2 redox cycling at 800 °C.” Chemical Engineering Journal 497 (2024): 154984.
[46]. Chen, Ming, Samuel Pennell, and David C. Dunand. “Tungsten's Role in Enhancing Sintering Resistance of Fe—W Hierarchical Foams during Redox Cycling.” Advanced Functional Materials (2024): 2411085.
[47]. Pennell, Samuel, and David C. Dunand. “Microstructure and phase evolution of Fe-20 Ni-20W foams during high-temperature redox cycling.” Scripta Materialia 249 (2024): 1 16177.
[48]. Pennell, Samuel, Ming Chen, and David C. Dunand. “Tungsten Strongly Inhibits Sinte ring of Porous Iron During High-Temperature Redox Cycling.” Small (2024): 2402174.
[49]. Mack, Jacob B., Samuel M. Pennell, and David C. Dunand. “Sintering inhibition enables hierarchical porosity with extreme resistance to degradation during redox cycling of Fe—Mo foams.” Acta Materialia 254 (2023): 119015.

What is claimed is:

1. A material for hydrogen production and storage, comprising:
a Fe-xSn powder blend capable of exhibiting a transient liquid-phase sintering induced swelling effect and undergoing reversible transformations throughout redox cycling between oxidized and reduced states, wherein x represents a concentration (at. %) of tin (Sn) in the powder blend and is in a range of about 0.5-40 at. %.

2. The material of claim 1, wherein the Fe-xSn powder blend is capable of undergoing the redox cycling under alternating hydrogen and steam atmospheres at temperatures between about 300 °C and about 800 °C.

3. The material of claim 2, wherein the Fe-xSn powder blend is configured such that during redox cycling, Sn forms a transient liquid phase that induces a swelling effect, resulting in the preservation of porosity and suppression of densification in the Fe-xSn powder blend over multiple redox cycles.

4. The material of claim 3, wherein the swelling effect is initiated at a temperature of at least 440 °C in a powder blend of Fe₂O₃ and SnO₂, corresponding to reduction of Fe₃O₄ and SnO₂ and subsequent intermetallic formation with Fe.

5. The material of claim 3, wherein the Sn concentration is about 25-40 at. % to achieve a balance between volume contraction due to oxide reduction and expansion from the swelling effect.

6. The material of claim 2, wherein the redox cycling occurs at approximately 650 °C under alternating streams of hydrogen and steam carried by an inert gas.

7. The material of claim 2, wherein the Fe-xSn powder blend exhibits the transient liquid-phase sintering induced swelling effect during hydrogen reduction due to the formation of liquid Sn, thereby preserving porosity and reactive surface area during at least 50 redox cycles.

8. The material of claim 7, wherein the porosity is generated via a combination of:
void formation at former Sn sites;
volumetric expansion from intermetallic Fe—Sn phase formation; and
suppression of sintering due to reduced solid-solid connectivity.

9. The material of claim 1, wherein the Fe-xSn powder blend comprises an iron (Fe) or Fe-containing powder and a Tin (Sn) or Sn-containing powder.

10. The material of claim 9, wherein the Fe or Fe-containing powder comprises a Fe powder, a Fe-rich powder, and/or a Fe-containing oxide powder, and the Sn or Sn-containing powder comprises a Sn powder, a Sn-rich powder, and/or a Sn-containing oxide powder.

11. The material of claim 10, wherein the Fe or Fe-containing powder comprises iron oxide (Fe₂O₃), and the Sn or Sn-containing powder comprises tin oxide (SnO₂).

12. The material of claim 11, wherein the redox cycling involves reversible transformations between Fe, FeO, Fe₃O₄, Sn, SnO₂, and Fe—Sn intermetallic phases.

13. The material of claim 11, wherein the Fe-xSn powder blend is produced by ball milling Fe₂O₃ and SnO₂ powders followed by chemical cycling without the use of shaping techniques such as freeze casting or 3D printing.

14. The material of claim 1, wherein the Fe-xSn powder blend is of Fe-1Sn, Fe-5 Sn, Fe-10 Sn, Fe-18 Sn, Fe-20 Sn, Fe-25 Sn, Fe-30 Sn, Fe-33 Sn, or Fe-40 Sn.

15. The material of claim 1, wherein the Fe-xSn powder blend achieves a hydrogen storage capacity of up to about 261 mL/g after 50 cycles.

16. A material for hydrogen production and storage, comprising:
a powder blend comprising an iron (Fe) or Fe-containing compound and a tin (Sn) or Sn-containing compound,
wherein the powder blend is configured to undergo reversible redox cycling between oxidized and reduced states under alternating hydrogen and steam atmospheres at a temperature between about 300 °C and about 800 °C;
wherein the powder blend exhibits a transient liquid-phase sintering induced swelling effect during the redox cycling, wherein tin forms a transient liquid phase that diffuses and induces volumetric expansion, thereby generating and preserving porosity and suppressing densification of the powder blend over multiple redox cycles.

17. A redox system for hydrogen production and storage, comprising:
a powder bed comprising a Fe-xSn powder blend capable of exhibiting a transient liquid-phase sintering induced swelling effect and undergoing reversible transformations throughout redox cycling between oxidized and reduced states, wherein x represents a concentration (at. %) of tin (Sn) in the powder blend and is in a range of about 0.5-40 at. %;
a redox reactor configured to alternately expose the powder bed to a hydrogen-containing gas and a steam-containing gas; and
a heating module configured to maintain the powder bed at a temperature between about 300 °C and about 800 °C during operation.

18. The redox system of claim 17, wherein the Fe-xSn powder blend is capable of undergoing the redox cycling under alternating hydrogen and steam atmospheres at temperatures between about 300 °C and about 800 °C.

19. The redox system of claim 18, wherein the Fe-xSn powder blend is configured such that during redox cycling, Sn forms a transient liquid phase that induces a swelling effect, resulting in the preservation of porosity and suppression of densification in the Fe-xSn powder blend over multiple redox cycles.

20. The redox system of claim 19, wherein the swelling effect is initiated at a temperature of at least 440 °C, corresponding to onset of Sn melting and intermetallic formation with Fe.

21. The redox system of claim 19, wherein the Sn concentration is about 25-40 at. % to achieve a balance between volume contraction due to oxide reduction and expansion from the swelling effect.

22. The redox system of claim 17, wherein the heating module is configured to maintain the temperature at approximately 650 °C.

23. The redox system of claim 17, wherein the Fe-xSn powder blend exhibits the transient liquid-phase sintering induced swelling effect during hydrogen reduction due to the formation of liquid Sn, thereby preserving porosity and reactive surface area during at least 50 redox cycles.

24. The redox system of claim 23, wherein the powder bed comprises porosity formed at locations previously occupied by molten tin.

25. The redox system of claim 23, wherein the porosity is maintained through volumetric expansion of Fe-containing intermetallic phases and reduced particle connectivity.

26. The redox system of claim 25, wherein the powder bed further comprises Fe—Sn intermetallic phases including FeSn, Fe₃Sn₂, and/or Fe₅Sn₃.

27. The redox system of claim 17, wherein the Fe-xSn powder blend comprises an iron (Fe) or Fe-containing powder and a Tin (Sn) or Sn-containing powder.

28. The redox system of claim 27, wherein the Fe or Fe-containing powder comprises a Fe powder, a Fe-rich powder, and/or a Fe-containing oxide powder, and the Sn or Sn-containing powder comprises a Sn powder, a Sn-rich powder, and/or a Sn-containing oxide powder.

29. The redox system of claim 28, wherein the Fe or Fe-containing powder comprises iron oxide (Fe₂O₃), and the Sn or Sn-containing powder comprises tin oxide (SnO₂).

30. The redox system of claim 29, wherein the redox cycling involves reversible transformations between Fe, FeO, Fe₃O₄, Sn, SnO₂, and Fe—Sn intermetallic phases.

31. The redox system of claim 17, wherein the system achieves a hydrogen storage capacity of up to about 261 mL/g after 50 cycles.

32. The redox system of claim 17, wherein the system achieves at least 50 redox cycles with less than 25% loss of hydrogen storage capacity.

33. The redox system of claim 17, wherein the reactor includes an inlet for hydrogen gas and an inlet for water vapor carried by an inert gas.

34. The redox system of claim 17, wherein the system avoids the need for mechanical structuring processes including freeze casting or 3D printing to maintain powder morphology.

35. A method for cyclic hydrogen production and storage, comprising:
providing a powder bed comprising a Fe-xSn powder blend capable of exhibiting a transient liquid-phase sintering induced swelling effect and undergoing reversible transformations throughout redox cycling between oxidized and reduced states, wherein x represents a concentration (at. %) of tin (Sn) in the powder blend and is in a range of about 0.5-40 at. %;
heating the powder bed to a temperature between about 300 °C and about 800 °C; and
alternately introducing a hydrogen-containing (H₂) gas and steam-containing (H₂O vapor) gas into the powder bed;
wherein during reduction, Sn forms a transient liquid phase that induces a swelling effect, generating and preserving porosity in the powder bed.

36. The method of claim 35, wherein the hydrogen-containing gas comprises pure hydrogen and the steam-containing gas comprises water vapor carried by an inert gas.

37. The method of claim 35, wherein the redox cycle comprises a period of time of hydrogen exposure followed by the period of time of steam exposure.

38. The method of claim 35, wherein during the reduction, voids are formed at locations of former Sn particles.

39. The method of claim 35, wherein liquid Sn reacts with metallic iron to form Fe—Sn intermetallic phases that contribute to volumetric expansion and porosity stabilization.
